(19) United States
(12) Patent Application Publication
(10) Pub. No.: US 2009/0246858 A1
(43) Pub. Date: Oct. 1, 2009

(54) DRAIN TREATMENT SYSTEM

(76) Inventor: James E. Wray, Modesto, CA (US)

Correspondence Address: FULBRIGHT AND JAWORSKI LLP, 555 S. FLOWER STREET, 41ST FLOOR, LOS ANGELES, CA, 90071, US

(21) Appl. No.: 12/347,393

(22) Filed: Dec. 31, 2008

Related U.S. Application Data
(60) Provisional application No. 61/072,154, filed on Mar. 29, 2008.

(51) Int. Cl. C02F 3/28; B08B 9/027

(52) U.S. Cl. 435/264; 134/93; 435/262

(57) ABSTRACT

A drain treatment system includes a puck containment basket having an open top, sides, a bottom attached to the sides, and a rim attached to the sides at the open top. The sides and bottom of the puck containment basket have openings to permit liquid flow while restricting passage of solid debris. The system includes a cover that is movable or attachable to the puck containment basket at the open top or at the rim. The cover has openings to permit liquid flow while restricting the passage of solid debris. The cover can be positioned over the open top formed in the rim of the puck containment basket to form an enclosure. A drain treatment puck is insertable in and removable from the enclosure. Selected micro-organisms in the drain treatment puck are dispersed by the liquid and reduce clogging in the drain by a digestive action of the micro-organisms.

The present invention generally relates to plumbing. More specifically, the present disclosure relates to a treatment system to reduce drain clogs.

### BACKGROUND

Drains are found in commercial kitchens, restrooms and urinals among other places. A grid or mesh structure is often placed over the drain to catch debris such as food or other particulates to prevent solid debris from entering and potentially clogging the drain and to facilitate easy collection and removal of the debris.

Notwithstanding the grid or mesh structure over the drain, debris of small enough size as well as fats, oil and grease, and sludge can pass through the arid structure and can accumulate to clog drain pipes, leading to backed up sewer lines, mop sinks, urinals, etc., causing foul odors, build-up, and sewer discharge adversely impacting public health and environmental safety. This can result in facility down-time, costly sewer line clearing, pollution and disease.

Therefore, there is a need to provide a system to restrict passage of solid debris into a drain and thereafter to treat and dissolve drain build-up from debris and other matter that passes through the grid structure and that may still clog a sewer drain system.

### SUMMARY

A drain treatment system placed in a drain includes a puck containment basket having an open top, sides, a bottom attached to the sides, and a rim attached to the sides at the open top, the sides and bottom of the puck containment basket having openings to permit a flow of a liquid while restricting a passage of solid debris. The system includes a cover that is movable and/or attachable to the sides of the puck containment basket at the open top and/or at the rim. The cover has openings to permit the flow of the liquid while restricting the passage of the solid debris. The cover can be positioned over the open top formed in the rim of the puck containment basket to form an enclosure. A drain treatment puck is insertable in and removable from the enclosure. Selected micro-organisms in the drain treatment puck dispersed by the liquid may reduce clogging in the drain by a digestive action of the micro-organisms.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific embodiments disclosed may be readily utilized as a basis for modifying or designing other embodiments for carrying out the same purposes of the present disclosure. It should also be realized by those skilled in the art that such equivalent constructions do not depart from the technology of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present invention, reference is now made to the following description taken in conjunction with the accompanying drawings.

FIGS. 1A and 1B show two views of an embodiment of a drain treatment system according to the disclosure.

FIGS. 2A and 2B show two views of an embodiment of a drain treatment system according to the disclosure.

FIGS. 3A and 3B show two embodiments of a slidable cover of the drain treatment system of FIG. 2.

### DETAILED DESCRIPTION

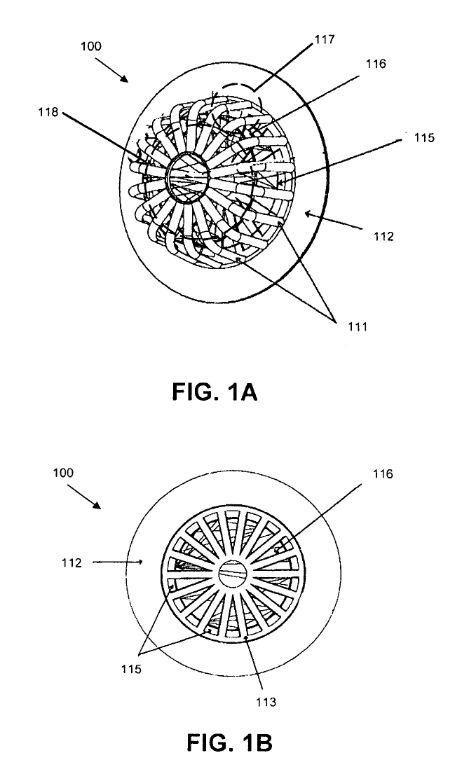

FIG. 1A shows a first view of an embodiment of a drain treatment system 100 in accordance with the disclosure. The drain treatment system 100 can be placed in a drain entry location above a pipe drainage system. Such drain entry locations may include, but are not limited to, floor basins, kitchen food preparation sinks, mop sinks, urinals and the like. The drain treatment system 100 includes a puck containment basket 111 configured to hold a drain treatment puck 116, discussed in more detail below. The puck containment basket 111 has sides 117, a bottom 118 attached to the sides 117, and openings 115 to permit the flow of liquid while restricting the passage of solid debris. The details of the dimensions of the openings 115 may vary to give the appearance, for example, of structural ribs, as shown in FIG. 1A.

The drain treatment system 100 holds a drain treatment puck 116 that may, for example, be dissolvable, may deodorize the drain and pipes, and further includes a treatment material such as a selected micro-organisms (e.g., American Type Culture Collection (ATCC) Class 1 organisms) which may be biodegradable. When dispersed by the effect of fluid flow dissolving the drain treatment puck 116, the selected micro-organisms may be capable of digesting and dissolving grease, fat, sludge, organic or other debris that may accumulate in the pipe drainage system below the drain in which the drain treatment system 100 is placed. A digestive action of the selected micro-organisms is preferably non-damaging to the pipe drainage system. The pipes may then have a reduced likelihood of clogging. Biodegradable forms of the drain treatment puck 116, such as described above, are commercially available (e.g., Genzyme Bio-Brick™ and Genzyme Bio-Block™, Genesis Technologies, Lawrenceville, Ga.).

The drain treatment system 100 also includes a rim 112 attached to an end of the sides 117 opposite the bottom 118 of the puck containment basket 111 making a surface large enough to prevent the drain treatment system 100 from entering the pipe drainage system above which it is placed.

In various embodiments, the puck containment basket 111 may be round, oval, square or rectangular, or have another shape. The shape may be determined by the shape of the drain treatment puck 116 and/or the drain. The rim 112 may be variously shaped for similar or equivalent reasons.

FIG. 1B shows a view of the drain treatment system 100 of FIG. 1A from the opposite side. The drain treatment system 100 includes a cover 113 that is, for example, movable and/or entirely removable. In an embodiment, the cover 113 may lock in place by conformable complementary features (not shown) on the cover 113 and the rim 112, to “snap” the cover 113 in place over an open top (beneath the cover 113, not shown). This forms a “cage” to hold the drain treatment puck 116 in the puck containment basket 111. The cover 113 may be removed to replace the drain treatment puck 116 when it is completely dissolved or depleted of micro-organisms or other treatment material. Alternatively, the cover 113 may lock to the rim 112 by rotating to be secured by the rim 112 or the sides 117 of the puck containment basket 111, such as by a screw thread arrangement, twist-lock mechanism, or the like. Various equivalent locking mechanism may be contemplated within the scope of the disclosure.

Any solid debris that accumulates in and around the drain treatment system 100 as a result of being blocked by the puck containment basket 111 may be removed and discarded. The drain treatment system 100 may be removed from the drain to facilitate discarding of the debris. Furthermore, the drain treatment system 100 may be deployed in a drain location in either of two orientations, i.e., with (1) the cover 113 facing downward and toward the drain, or (2) the cover 113 facing upward, with the puck containment basket 111 facing toward, or perhaps recessed into, the drain. In the first orientation, the sides 117, bottom 118 and the rim 112 form the principal locations for accumulation of debris that is prevented from passing through the openings 115. In the second orientation, the cover 113 and the opposite side of the rim 112 form the principal locations for accumulation of debris that is prevented from passing through the openings 115. In either orientation, the micro-organisms dispersed from the drain treatment puck function to reduce clogging in the drainage system.

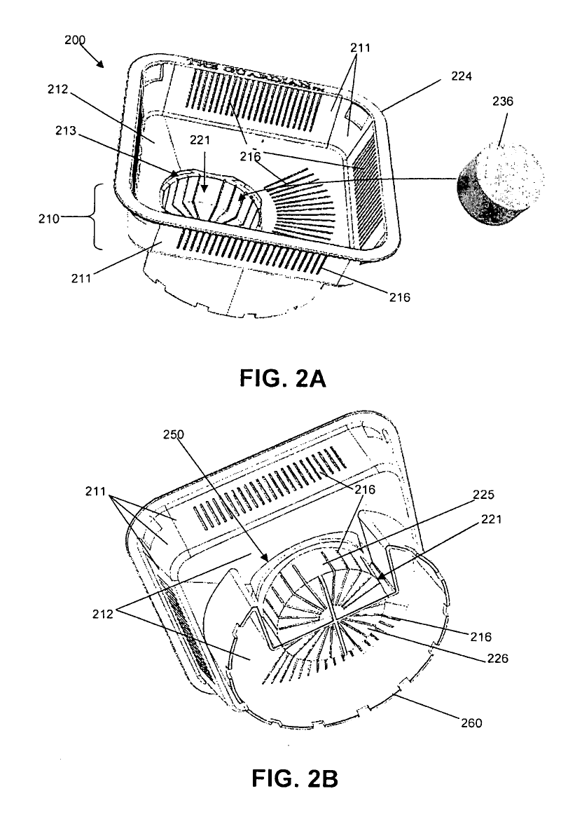

FIGS. 2A and 2B show a second embodiment of a drain treatment system 200 in accordance with the disclosure. The drain treatment system 200 includes a drain basket 210 with basket sides 211 and a basket bottom 212 attached to the basket sides 211. A basket lip 224 may be attached to the basket sides 211 opposite the basket bottom 212. The basket lip 224 may have the purpose of making a surface large enough to prevent the drain treatment system 200 from entering the pipe drainage system above which it is placed. Both the basket sides 211 and the basket bottom 212 have openings 216, similar to the openings 115 of drain treatment system 100. The openings 216 permit the flow of liquid while restricting the passage of solid debris. The basket bottom 212 has a hole 213, which further permits the flow of liquid downward. The hole 213 may be offset from a center of the basket bottom 212. The basket bottom 212 of the drain basket 210 may serve at least a purpose analogous to the rim 112 of the drain treatment system 100. That is, the basket bottom 212 is a surface large enough to keep the drain treatment system 200 from entering the pipe drainage system above which it is placed. Additionally, it may be shaped to conform and fit the drain opening in which it is placed.

As shown in FIGS. 2A and 2B, the drain basket 210 and the basket bottom 212 are shown as having a square, or rectangular shape. The shape may be suitably chosen to meet the requirements of the drain in which it is placed.

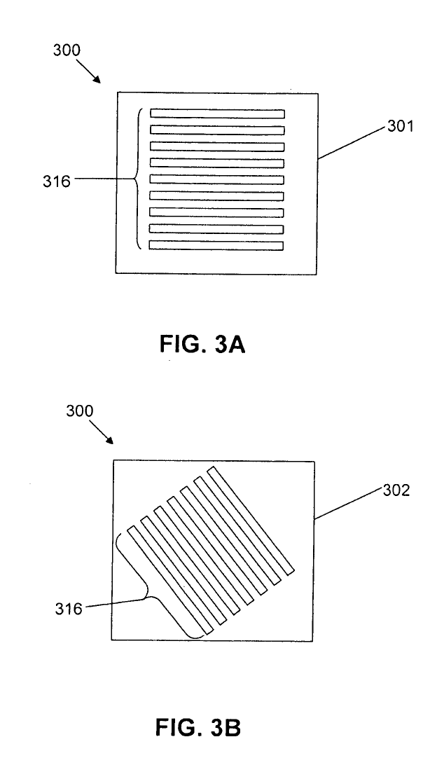

Aligned to the periphery of the hole 213, a puck containment basket 221 may be attached, as shown in FIGS. 2A and 2B. The puck containment basket 221 is the receptacle for a drain treatment puck 236. The drain treatment puck 236 is substantially the same as the drain treatment puck 116. The puck containment basket includes sides 225, a bottom 226 attached to the sides 225, and openings 216 to permit the flow of liquid while restricting the passage of solid debris. The sides 225 and the bottom 226 are analogous to the sides 117 and the bottom 118 of the drain treatment system 100. The puck containment basket 221 may be attached around the periphery of the hole 213 to include a slot 250. The slot 250 is provided to enable a cover plate 300 (shown in exemplary forms in FIGS. 3A and 3B) to slide between two extreme positions, i.e., to entirely cover the hole 213 in a closed position, or to expose the hole 213 in an open position. The cover plate 300 may be moved to the open position to insert or replace the drain treatment puck 236. Alternatively, the cover plate may be substantially the same as the cover 113 described above, and may attach to or remove from the hole 213 by use of conformal “snaps” or a screw thread or other equivalent structures, as previously described, to lock the cover plate in place, in which case the slot 250 is not required.

The drain treatment system 200 may have a base support 260 attached beneath the drain basket 210. The base support 260 may provide a selected height for the drain treatment system 200 when it is placed in a drain. The base support 260 may also provide for alignment to the pipe below the drain.

FIGS. 3A and 3B show two embodiments of the cover plate 300 of the drain treatment system 200 of FIGS. 2A and 2B. The cover plate 300 shown in FIGS. 3A and 3B can slide through the slot 250 to cover or expose the interior of the puck containment basket 221 that receives the drain treatment puck 236. A first slide cover plate 301, shown in FIG. 3A, is shown with a pattern of openings 316 arranged in a rectilinear pattern with a long dimension of the openings 316 aligned with two opposite edges of the first slide cover plate 301, where the openings 316 permit the flow of liquid while restricting the passage of solid debris. Analogously, a second slide cover plate 302, shown in FIG. 3B, has a pattern of openings 316 arranged in a rectilinear pattern with a long dimension of the openings 316 arranged approximately on a diagonal or other angle with respect to an edge of the second slide cover plate 302. Other patterns of openings, including radial patterns, arcs, or equivalents, may be formed in a cover plate 300 equivalent to slide cover plates 301, 302 in accordance with the disclosure. In all cases, the openings 316 are formed so as to permit the flow of liquid while restricting the passage of solid debris.

It may be appreciated that the various embodiments provide a two-fold drain treatment benefit, i.e., first, that debris larger than the openings are prevented from passing into the drain, and, second, that the digestive action of the micro-organisms dispersed from the drain treatment puck digest and dissolve accumulated fats, oils, greases, sludge, smaller organic debris and other clogged matter that does pass through the openings into the drain and which can clog drains below the drain basket.

It may be appreciated that the environmentally friendly micro-organisms released from the puck can maintain clear pipes throughout the drainage system. As the micro-organisms flow farther down the cleared drain lines, exterior drainage systems, such as community drainage can also benefit, reducing public and private drainage maintenance costs.

It may be further appreciated that embodiments of the disclosure may have beneficial value for community health by virtue of digestion and dissolution of accumulated sludge, etc., that may harbor potentially toxic chemicals, bacteria or viruses, by use of environmentally safe and friendly micro-organisms.

Although the present disclosure and its advantages have been described in detail, it should be understood that various changes, substitutions and alterations can be made herein without departing from the intent of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A drain treatment system for being placed in a drain comprising:
a puck containment basket having an open top, sides, a bottom attached to the sides, and a rim attached to the sides at the open top, the sides and bottom of the puck containment basket having openings to permit a flow of a liquid while restricting a passage of solid debris;
a cover, movable and/or attachable to the sides of the puck containment basket at the open top and/or the rim, the cover having openings to permit the flow of the liquid while restricting the passage of the solid debris, the cover positioned over the open top formed in the rim of the puck containment basket to form an enclosure; and
a drain treatment puck insertable in and removable from the enclosure.

2. The system of claim 1, further comprising:
a drain basket having basket sides, a basket bottom attached to the basket sides, the basket bottom comprising a hole, the puck containment basket, the cover and the rim, the basket sides and the basket bottom having openings to permit the flow of the liquid while restricting the passage of the solid debris, in which the open top is aligned with the hole; and
a basket lip attached to the basket sides opposite the basket bottom.

3. The system of claim 2, further comprising:
a slot between the puck containment basket and the drain basket, wherein the cover can movably slide laterally to close or expose the puck containment basket through the open top and the hole.

4. The system of claim 3, wherein the open top and the hole are offset from a center of the drain basket.

5. The system of claim 3, wherein the cover extend laterally up to an extent of the basket sides of the drain basket when exposing the puck containment basket through the open top and the hole.

6. The system of claim 1, wherein the cover can lock in place when positioned to form the enclosure, and can unlock when moved to expose the puck containment basket.

7. The system of claim 1, wherein the cover can lock in place by a screw rotational movement.

8. The system of claim 1, wherein the drain treatment puck includes micro-organisms adapted to digest and dissolve organic matter.

9. The system of claim 8, wherein the drain treatment puck is dissolvable in the liquid to release the micro-organisms into the drain beneath the system.

10. The system of claim 9, wherein the drain treatment puck removes organic matter accumulated in the drain by a digestive action of the micro-organisms.

11. The system of claim 1, wherein the drain treatment puck is replaceable by moving the cover to expose the puck containment basket in order to insert a second drain treatment puck.

12. The system of claim 1, wherein the drain treatment system is removable from the drain.

13. The system of claim 1, further comprising a base support, for providing a selected height of the drain treatment system and/or alignment to a pipe when placed in the drain.

14. A method of reducing accumulated clogging matter in drains comprising:
placing in a drain a drain treatment system adapted to permit a flow of a liquid while restricting a passage of solid debris;
placing a drain treatment puck having selected micro-organisms embedded in the drain treatment puck into the drain treatment system;
providing the flow of the liquid through the drain treatment system;
dispersing the selected micro-organisms in the liquid;
dissolving and removing clogged matter by a digestive action of the selected micro-organisms; and
removing the solid debris accumulated in the drain treatment system.

15. The method of claim 14, wherein the drain treatment puck may be placed in the drain treatment system before placing the drain treatment system in the drain.
